(19) United States
(12) Patent Application Publication
(10) Pub. No.: US 2026/0178011 A1
(43) Pub. Date: Jun. 25, 2026

(54) NUMERICAL CONTROL DEVICE AND PROGRAM

(71) Applicant: FANUC CORPORATION, Minamitsuru-gun, Yamanashi (JP)

(72) Inventor: Jun YAGI, Yamanashi (JP)

(73) Assignee: FANUC CORPORATION, Minamitsuru-gun, Yamanashi (JP)

(21) Appl. No.: 18/854,902

(22) PCT Filed: Jun. 7, 2022
(86) PCT No.: PCT/JP2022/022963

§ 371 Date: Oct. 7, 2024

(51) Int. Cl. G05B 19/4155

(52) U.S. Cl. CPC G05B 19/4155; G05B 2219/35216

(57) ABSTRACT

The numerical control device of an embodiment comprises a compressing unit, a calculating unit, and a holding unit. The compressing unit compresses a first command point sequence to create a second command point sequence. The calculating unit calculates an execution position of the operation in the second command point sequence, for a first output command that is held in the first command point sequence and instructs an industrial machine to perform the operation. The holding unit causes the second command point sequence to hold a second output command for instructing the industrial machine to perform the operation at the execution position.

### TECHNICAL FIELD

The present invention relates to a numerical control device and a program.

### BACKGROUND ART

Some numerical control devices that perform numerical control (NC) have a function called command point sequence compression. The command point sequence compression function is a function of compressing a command point sequence (hereinafter sometimes simply referred to as “point sequence”). That is, the command point sequence compression function is a function of interpolating a command path including a plurality of point sequences with a smaller number of straight lines or curves. Through use of the command point sequence compression function, a load of the numerical control device can be reduced. In this manner, the command point sequence compression function can suppress speed reduction to be caused by insufficient performance of the numerical control device.

### CITATION LIST

### Patent Document

Patent Document 1: Japanese Unexamined Patent Application, Publication No. 2015-153097

### DISCLOSURE OF THE INVENTION

### Problems to be Solved by the Invention

In the conventional numerical control, the timing to execute an output command varies depending on each point sequence. Accordingly, when the point sequence is compressed, the number of timings at which the output command can be executed is reduced. As a result, in some cases, an accuracy of an operation such as machining performed by an industrial machine is decreased.

An object to be achieved by an embodiment of the present invention is to provide a numerical control device and a program that can prevent an accuracy of an operation such as machining from decreasing when a command point sequence is compressed.

### Means for Solving the Problems

A numerical control device of an embodiment includes a compressing unit, a calculating unit, and a holding unit. The compressing unit compresses a first command point sequence to create a second command point sequence. The calculating unit calculates an execution position of the operation in the second command point sequence, for a first output command that is held by the first command point sequence and instructs an industrial machine to execute the operation. The holding unit causes the second command point sequence to hold a second output command for instructing the industrial machine to execute the operation at the execution position.

### Effects of the Invention

The present invention can prevent the accuracy of the operation such as machining from decreasing when the command point sequence is compressed.

### BRIEF DESCRIPTION OF THE DRAWINGS

FIG. 1 is a block diagram illustrating an example of a numerical control system according to an embodiment and main features of components included in the numerical control system;

FIG. 2 is a flowchart illustrating an example of processing performed by a processor in FIG. 1;

FIG. 3 is a diagram illustrating an example of a point sequence before compression;

FIG. 4 is a diagram illustrating an example of a point sequence after compression; and

FIG. 5 is a diagram illustrating an example of a section in which an operation instructed by an output command is executed, in an example of the point sequence after compression.

### PREFERRED MODE FOR CARRYING OUT THE INVENTION

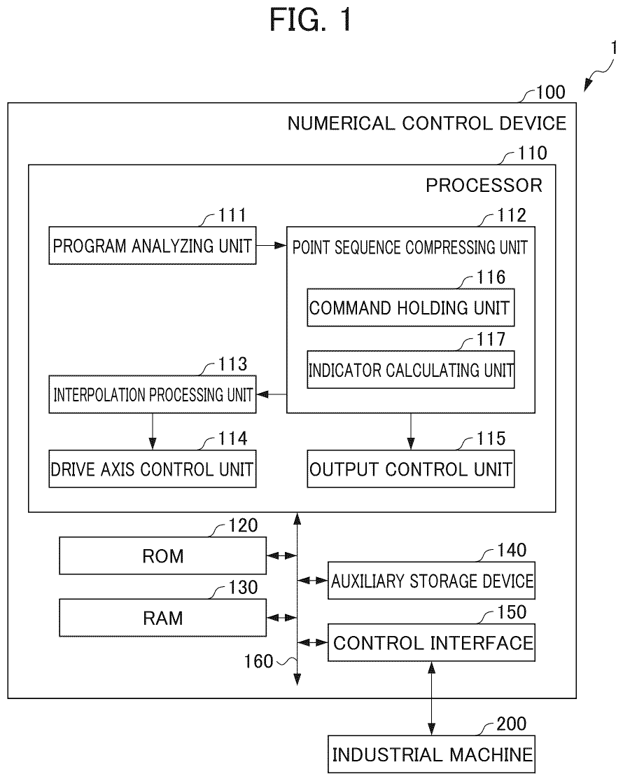

Hereinafter, a numerical control system according to an embodiment is described with reference to the drawings. Note that, in each drawing used for the description of the embodiment below, in some case, scales of each portion are changed as appropriate. Further, in some cases, each drawing used for the description of the embodiment below is shown with a configuration being omitted for the sake of description. Further, throughout the drawings and the specification, the same reference symbols indicate similar elements. Further, in the drawings and in the specification and claims, a curve includes a straight line. FIG. 1 is a block diagram illustrating an example of a numerical control system 1 according to the embodiment and main features of components included in the numerical control system 1. The numerical control system 1 includes, as an example, a numerical control device 100 and an industrial machine 200.

The numerical control device 100 is a device that performs numerical control with respect to an industrial machine or the like. The numerical control device 100 includes, as an example, a processor 110, a ROM (read-only memory) 120, a RAM (random-access memory) 130, an auxiliary storage device 140, and a control interface 150. In addition, a bus 160 or the like connects those units.

The processor 110 is a core part of a computer that performs processing such as calculation and control necessary for an operation of the numerical control device 100, and performs various types of calculation and processing. Examples of the processor 110 include a CPU (central processing unit), an MPU (micro processing unit), an SoC (system on a chip), a DSP (digital signal processor), a GPU (graphics processing unit), an ASIC (application specific integrated circuit), a PLD (programmable logic device), and an FPGA (field-programmable gate array). As another example, the processor 110 is a combination of a plurality of those units. Further, the processor 110 may be a combination of those units with a hardware accelerator or the like. The processor 110 controls the units to implement various functions of the numerical control device 100 based on programs such as firmware, system software, and application software stored in the ROM 120 or the auxiliary storage device 140. Further, the processor 110 executes processing to be described later based on the program. Note that a part or the whole of the program may be incorporated in a circuit of the processor 110. The processor 110 functions as, based on the program, as an example, a program analyzing unit 111, a point sequence compressing unit 112, an interpolation processing unit 113, a drive axis control unit 114, and an output control unit 115.

The program analyzing unit 111 analyzes the content of an NC program. Thus, the program analyzing unit 111 identifies what kind of operation and control the NC program causes the numerical control device 100 to execute.

The point sequence compressing unit 112 compresses the point sequence. The point sequence compressing unit 112 includes, as an example, a command holding unit 116 and an indicator calculating unit 117.

The command holding unit 116 causes a point sequence after compression to include an output command similar to that before compression

The indicator calculating unit 117 calculates an indicator I to be described later.

The interpolation processing unit 113 calculates an interpolation curve M to be described later.

The drive axis control unit 114 controls, based on the NC program, the industrial machine 200 to move along the point sequence.

The output control unit 115 controls, based on the output command of the NC program, the industrial machine 200 to execute an operation instructed by the output command.

The ROM 120 and the RAM 130 are main storage devices of the computer including the processor 110 as a core. The ROM 120 is a non-volatile memory that is exclusively used for readout of data. The ROM 120 stores, for example, firmware or the like out of the above-mentioned programs. Further, the ROM 120 also stores data or the like to be used when the processor 110 performs various types of processing. The RAM 130 is a memory used for reading and writing of data. The RAM 130 is used as a work area or the like that stores data to be temporarily used when the processor 110 performs various types of processing. The RAM 130 is typically a volatile memory.

The auxiliary storage device 140 is an auxiliary storage device of the computer including the processor 110 as a core. Examples of the auxiliary storage device 140 include an EEPROM (electric erasable programmable read-only memory), an HDD (hard disk drive), and a flash memory. The auxiliary storage device 140 stores, for example, system software, application software, or the like out of the above-mentioned programs. Further, the auxiliary storage device 140 stores data to be used when the processor 110 performs various types of processing, data generated by the processing performed by the processor 110, various setting values, and the like.

Further, the auxiliary storage device 140 stores an NC program for controlling the industrial machine 200. A part of an example of the NC program before compression is shown below.
N1 G01 X1. S0;

### N2 G01 X1. S1000;

### N3 G01 X1. S0;

### N4 G01 X1. S1000;

In this NC program, one row indicates one operation. N1 to N4 indicate sequence numbers. G01 indicates cutting feed. Xx (x is any numerical value) indicates movement by x millimeters in an X direction. Further, x is a numerical value for giving an instruction of a moving amount of a tool. X1 indicates movement by 1 millimeter in the X direction. Ss (s is an integer of 0 or more) indicates a machining output command of laser. Further, s is a numerical value for giving an instruction of a power output value of the laser. S1000 indicates that power of 1,000 watts is output. S0 indicates that power of 0 watt is output, that is, no laser is output. Note that a machining output command is an output command for instructing the industrial machine 200 to perform machining. An output command is a command for instructing the industrial machine 200 to perform any kind of operation. Each output command included in the NC program is an output command held by the NC program.

Thus, the first row (row of N1) of this NC program indicates instructing the industrial machine 200 to move by 1 millimeter in the X direction while performing laser machining. Further, in this NC program, the movement corresponding to one row indicates movement from an end point to a next end point included in a command path.

As described above, in the NC program, the output command can be output for each movement.

Some machining output commands give an instruction of gas cutting or electrical discharge machining other than laser machining.

The control interface 150 is an interface for allowing the numerical control device 100 to communicate with the industrial machine 200 or the like. The numerical control device 100 controls the industrial machine 200 or the like via the control interface 150.

The bus 160 includes a control bus, an address bus, a data bus, and the like, and transmits signals to be transferred between the units of the numerical control device 100.

The industrial machine 200 is a machine that operates based on numerical control. Examples of the industrial machine 200 include a manipulator, a robot arm, a robot, and a machine tool. Examples of the machine tool include an NC lathe, an NC milling machine, a laser machining machine, a gas cutting machine, and an electrical discharge machining machine.

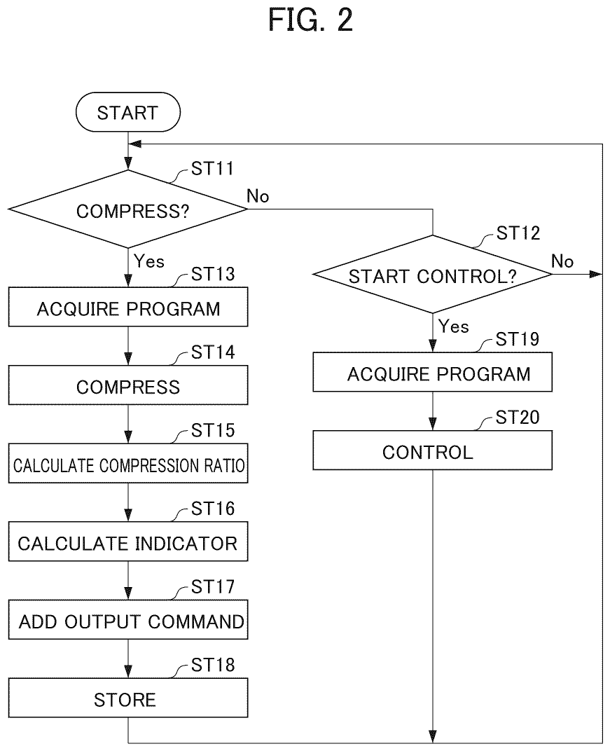

Hereinafter, the operation of the numerical control system 1 according to the embodiment is described with reference to FIG. 2 and others. Note that the content of the processing in the operation description below is merely an example, and various types of processing that can obtain similar results can be used as appropriate. FIG. 2 is a flowchart illustrating an example of processing performed by the processor 110 of the numerical control device 100. The processor 110 executes, for example, the processing of FIG. 2 based on a program stored in the ROM 120, the auxiliary storage device 140, or the like.

In Step ST11 of FIG. 2, the processor 110 of the numerical control device 100 determines whether or not to compress the point sequence. The processor 110 determines to compress the point sequence when, for example, the processor 110 has received an input of an instruction to compress the point sequence. The input is input to the numerical control device 100 via, for example, an input device. As another example, the instruction is input to the numerical control device 100 from another device. Further, for example, when the auxiliary storage device 140 includes an uncompressed NC program, the processor 110 determines to compress the point sequence for the NC program at a predetermined timing. Further, for example, when an NC program is input to the numerical control device 100, the processor 110 determines to compress the point sequence for the NC program. When the processor 110 determines not to compress the point sequence, the processor 110 makes a determination of No in Step ST11 and proceeds to Step ST12.

In Step ST12, the processor 110 determines whether or not to start the numerical control for the industrial machine 200. The processor 110 determines to start the numerical control when, for example, the processor 110 has received an input of an instruction to start the numerical control for the industrial machine 200. The input is input to the numerical control device 100 via, for example, an input device. As another example, the instruction is input to the numerical control device 100 from another device. Further, for example, the processor 110 determines to start the numerical control for the industrial machine 200 at a predetermined timing. When the processor 110 determines not to start the numerical control, the processor 110 makes a determination of No in Step ST12 and returns to Step ST11. Thus, the processor 110 is brought to a standby state of repeating Step ST11 and Step ST12 until the processor 110 determines to compress the point sequence or determines to start the numerical control.

When the processor 110 determines to compress the point sequence when the processor 110 is in the standby state of Step ST11 and Step ST12, the processor 110 makes a determination of Yes in Step ST11 and proceeds to Step ST13.

In Step ST13, the processor 110 acquires an NC program that is a target of the point sequence compression. The processor 110 acquires the NC program from, for example, the auxiliary storage device 140. As another example, the processor 110 may acquire the NC program from another device. Note that the NC program acquired in the most recent processing of Step ST13 is hereinafter referred to as “acquired program”.

In Step ST14, the processor 110 compresses the point sequence for the NC program acquired in Step ST13. The processor 110 can use a publicly-known method as a method of compressing the point sequence. As an example, the processor 110 can use the compression method as described in Patent Document 1.

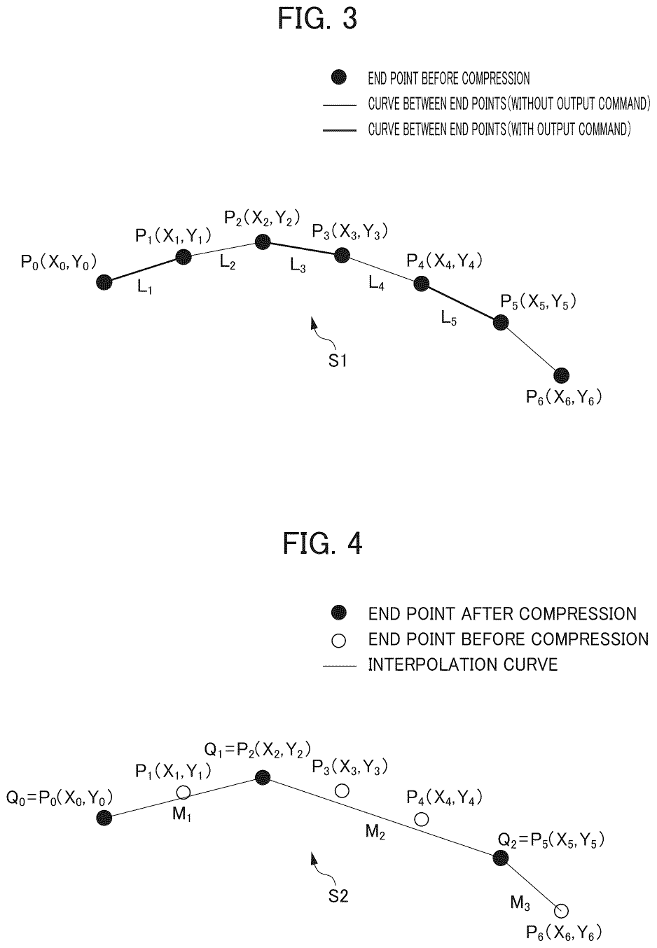

The point sequence before compression and the point sequence after compression are described with reference to FIG. 3 and FIG. 4. FIG. 3 is a diagram illustrating an example of a point sequence S1 before compression. The point sequence S1 is a command point sequence including (n+1) end points of an end point P0 to an end point Pn. Here, n is a positive integer. Note that FIG. 3 illustrates only the end point P0 to the end point P6 out of the end points P of the point sequence S1. Further, coordinates of an end point Pi and the component representation of a vector Pi are represented by (Xi, Yi).

Each curve Li between the end points in FIG. 3 is a straight line connecting a point P(i−1) and a point Pi to each other. Here, i is an integer between 0 and n inclusive. Note that the curve between the end points may be a curve that is not a straight line.

Further, when the curve Li between the end points that is a straight line is represented by a vector, this straight line can be expressed by the following expression (1).

$$\begin{matrix}[ Math . 1 ] & \\ \begin{matrix}{L}_{i} = {P}_{i} - {P}_{i - 1} \\ = ( ( {X}_{i} - {X}_{i - 1} ) , ( {Y}_{i} - {Y}_{i - 1} ) )\end{matrix} & ( 1 )\end{matrix}$$

Note that the bold letter indicates a vector.

Note that the thick line in the curve L between the end points illustrated in FIG. 3 indicates movement including an output command. A thin line in the curve L between the end points indicates movement including no output command.

FIG. 4 is a diagram illustrating an example of a point sequence S2 after compression. The point sequence S2 is a point sequence obtained by compressing the point sequence S1. The point sequence S2 is a command point sequence including (m+1) end points of an end point Q0 to an end point Qm. Here, m is an integer between 1 and n inclusive. Note that FIG. 4 illustrates only the end point Q0 to the end point Q2 out of the end points Q of the point sequence S2. Further, FIG. 4 also illustrates the end points P before compression.

In the point sequence S2, the number of point sequences is reduced from (n+1) to (m+1) through the compression of the point sequence. As is understood from FIG. 3 and FIG. 4, three end points P of the end point P0 to the end point P2 are compressed to two end points Q of the end point Q0 and the end point Q1. That is, two curves L of a curve Li and a curve L2 are compressed to one curve M1. Further, four end points P of the end point P2 to the end point P5 are compressed to two end points Q of the end point Q1 and the end point Q2. That is, three curves L of a curve L3 to a curve L5 are compressed to one curve M2.

Each interpolation curve Mj in FIG. 4 is a straight line connecting an end point Q(j−1) and an end point Qj to each other. Here, j is an integer between 0 and m inclusive. Note that the interpolation curve M may be a curve that is not a straight line.

Further, when the interpolation curve Mj that is a straight line is represented by a vector, this straight line can be expressed by the following expression (2).

$$\begin{matrix}[ Math . 2 ] & \\ \begin{matrix}{M}_{j} = {Q}_{j} - {Q}_{j - 1} \\ = {P}_{k 2} - {P}_{k 1} \\ = ( ( {X}_{k 2} - {X}_{k 1} ) , ( {Y}_{k 2} - {Y}_{k 1} ) )\end{matrix} & ( 2 )\end{matrix}$$

Here, the interpolation curve Mj is an interpolation curve M obtained by compressing an end point Pk1 to an end point Pk2. That is, the end point Pk1 is an end point matching the end point Q(j−1). Further, the end point Pk2 is an end point matching the end point Qj. In addition, (k2−k1) is the number of curves L between the end points before compression of the interpolation curve Mj. In other words, (k2−k1) is (“the number of end points before compression of the interpolation curve Mj”−1).

The point sequence before compression is an example of a first command point sequence. The point sequence S1 is an example of the first command point sequence. The point sequence after compression is an example of a second command point sequence. The point sequence S2 is an example of the second command point sequence. As described above, the processor 110 performs the processing of Step ST14 to function as an example of a compressing unit that compresses the first command point sequence to create the second command point sequence.

In Step ST15, the processor 110 calculates a compression ratio R of each interpolation curve M. The compression ratio R is a ratio of a length of an interpolation curve M to a sum of lengths of the curves L between the end points before compression of the interpolation curve M. Thus, a compression ratio Rj of the interpolation curve Mj can be obtained by, for example, the following expression (3).

$$\begin{matrix}[ Math . 3 ] & \\ {R}_{j} = \frac{‖ {M}_{j} ‖}{{\sum }_{i = k 1 + 1}^{k 2} ‖ {L}_{i} ‖} & ( 3 )\end{matrix}$$

Note that the expression (3) indicates the length of the curve L between the end points and the length of the interpolation curve M by norms of vectors.

The processor 110 calculates a compression ratio R1 to a compression ratio Rm.

As an example, the compression ratio R1 of the interpolation curve M1 in FIG. 4 is obtained as the following expression (4).

$$\begin{matrix}[ Math . 4 ] & \\ \begin{matrix}{R}_{1} = \frac{‖ {M}_{1} ‖}{{\sum }_{i = 1}^{2} ‖ {L}_{i} ‖} \\ = \frac{‖ {P}_{2} - {P}_{0} ‖}{‖ {L}_{1} ‖ + ‖ {L}_{2} ‖} \\ = \frac{‖ {P}_{2} - {P}_{0} ‖}{‖ {P}_{1} - {P}_{0} ‖ + ‖ {P}_{2} - {P}_{1} ‖} \\ = \frac{\vert \sqrt{{( {X}_{2} - {X}_{0} )}^{2} + {( {Y}_{2} - {Y}_{0} )}^{2}} \vert}{\vert \sqrt{{( {X}_{1} - {X}_{0} )}^{2} + {( {Y}_{1} - {Y}_{0} )}^{2}} \vert + \vert \sqrt{{( {X}_{2} - {X}_{1} )}^{2} + {( {Y}_{2} - {Y}_{1} )}^{2}} \vert}\end{matrix} & ( 4 )\end{matrix}$$

In Step ST16, the processor 110 calculates the indicator I of each curve L between the end points. The indicator I indicates a length (distance) of a section in which an operation instructed by an output command is executed. An indicator Ii of the curve Li between the end points can be obtained by, for example, the following expression (5).

$$\begin{matrix}[ Math . 5 ] & \\ {I}_{i} = R \times ‖ {L}_{i} ‖ & ( 5 )\end{matrix}$$

R in the expression (5) is the compression ratio R of the interpolation curve M after compression of one or a plurality of curves between the end points including the curve Li between the end points.

The processor 110 calculates an indicator I1 to an indicator In.

As an example, the indicator I1 of the curve Li between the end points in FIG. 4 is obtained as the following expression (6).

$$\begin{matrix}[ Math . 6 ] & \\ \begin{matrix}{I}_{1} = {R}_{1} \times ‖ {L}_{1} ‖ \\ = \frac{\vert \sqrt{{( {X}_{2} - {X}_{0} )}^{2} + {( {Y}_{2} - {Y}_{0} )}^{2}} \vert \times \vert \sqrt{{( {X}_{1} - {X}_{0} )}^{2} + {( {Y}_{1} - {Y}_{0} )}^{2}} \vert}{\vert \sqrt{{( {X}_{1} - {X}_{0} )}^{2} + {( {Y}_{1} - {Y}_{0} )}^{2}} \vert + \vert \sqrt{{( {X}_{2} - {X}_{1} )}^{2} + {( {Y}_{2} - {Y}_{1} )}^{2}} \vert}\end{matrix} & ( 6 )\end{matrix}$$

In Step ST17, the processor 110 adds an output command to the point sequence after compression. The output command added here is an output command for giving an instruction to perform the same operation as that instructed by the output command included in the acquired program. However, an execution position of the operation of the output command added here is, as described later, different from the output command included in the acquired program in. The addition of the output command causes the NC program to hold this output command.

The output command for giving an instruction to perform the operation executed in the curve Li between the end points is represented by an output command Ci. Further, the interpolation curve M after compression of the curve Li between the end points is represented by an interpolation curve Mj. Further, a start position of the operation instructed by the output command is represented by a position V(i−1), and an end position thereof is represented by a position Vi.

The processor 110 adds each output command C to the point sequence after compression as an instruction to start the operation at the position V(i−1) and end the operation at the position Vi.

In the case of i=k1+1, the position V(i−1) is a position of a point Q(j−1).

In the case of i>k1+1, the position V(i−1) is a position advanced by a distance D(a−1) from the position of the point Q(j−1) along the interpolation curve Mj. The distance D(a−1) is expressed as follows.

$$\begin{matrix}[ Math . 7 ] & \\ {D}_{a - 1} = {\sum }_{s = k 1 + 1}^{i - 1} {I}_{s} & ( 7 )\end{matrix}$$

In the case of i≠k2, the position Vi is a position advanced by a distance Da from the position of the point Q(j−1) along the interpolation curve Mj. The distance Da is expressed as follows.

$$\begin{matrix}[ Math . 8 ] & \\ {D}_{a} = {\sum }_{s = k 1 + 1}^{i} {I}_{s} & ( 8 )\end{matrix}$$

As another example, the distance Da satisfies Da=D(a−1)+Ii.

In the case of i=k2, the position Vi is a position of a point Qj.

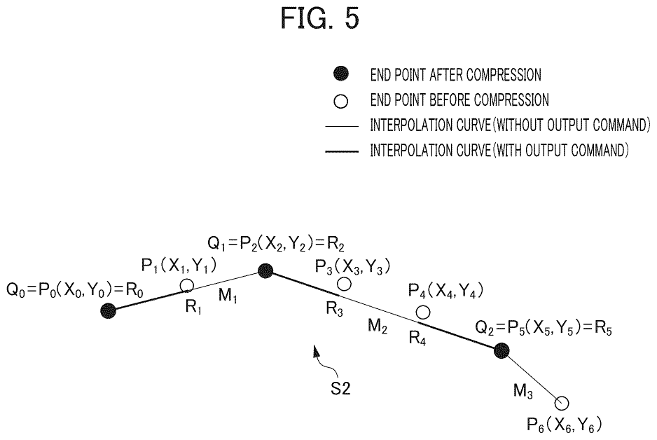

FIG. 5 is a diagram illustrating an example of a section in which an operation instructed by the output command is executed, in an example of the point sequence S2 after compression. FIG. 5 illustrates sections in which operations instructed by an output command C1, an output command C3, and an output command C5 are executed. A section from the position V0 to the position V1 is a section in which the operation instructed by the output command C1 is executed. A section from the position V2 to the position V3 is a section in which the operation instructed by the output command C3 is executed. A section from the position V4 to the position V5 is a section in which the operation instructed by the output command C5 is executed. Note that, in the example of FIG. 5, the output command C2 and the output command C4 are absent in the acquired program.

Further, FIG. 3 illustrates the section in which the operation instructed by the output command is executed as well. In FIG. 3, a section from a point P0 to a point P1, that is, a section on a curve Li between the end points is a section in which the operation instructed by the output command C1 is executed

A section from a point P2 to a point P3, that is, a section on a curve L3 between the end points is a section in which the operation instructed by the output command C3 is executed. A section from a point P4 to a point P5, that is, a section on a curve L5 between the end points is a section in which the operation instructed by the output command C5 is executed.

As described above, with the processing of Step ST14 to Step ST17, the processor 110 converts the acquired program into an NC program indicating the point sequence after compression.

As described above, the processor 110 performs the processing of Step ST16 and Step ST17 to function as an example of a calculating unit that calculates an execution position of the operation in the second command point sequence, for a first output command that is held by the first command point sequence and instructs the industrial machine to execute the operation. Further, the processor 110 performs the processing of Step ST17 to function as an example of a holding unit that causes the second command point sequence to hold a second output command for instructing the industrial machine to execute the operation at the execution position.

In Step ST18, the processor 110 stores the NC program converted by the processing of Step ST14 to Step ST17 into the auxiliary storage device 140. Further, the processor 110 may delete or move the acquired program to prevent the acquired program from being erroneously executed. The processor 110 returns to Step ST11 after executing the processing of Step ST18.

Meanwhile, when the processor 110 determines to start the numerical control when the processor 110 is in the standby state of Step ST11 and Step ST12, the processor 110 makes a determination of Yes in Step ST12 and proceeds to Step ST19.

In Step ST19, the processor 110 acquires the NC program to be executed. Which NC program is to be acquired is included in, for example, the input of instructing the industrial machine 200 to start the numerical control. The NC program acquired here is, for example, the NC program stored in Step ST18.

In Step ST20, the processor 110 executes the NC program acquired in Step ST19 to perform numerical control of the industrial machine 200. The processor 110 returns to Step ST11 after executing the processing of Step ST20.

According to the numerical control system 1 of the embodiment, the numerical control device 100 compresses the point sequence. In this manner, the numerical control device 100 of the embodiment can reduce the load.

Further, according to the numerical control system 1 of the embodiment, the numerical control device 100 compresses the point sequence. Further, the numerical control device 100 of the embodiment calculates the position V as a position at which the operation is executed in the point sequence after compression. This operation is an operation instructed by the output command held by the command point sequence before compression. Further, the numerical control device 100 of the embodiment causes the command point sequence after compression to hold the command point sequence giving an instruction to execute the operation at a position based on the position V. In this manner, in the point sequence after compression, the number of times of the timing at which the output command can be executed is the same as that in the point sequence before compression. Accordingly, the numerical control device 100 of the embodiment can prevent the accuracy of the operation such as machining from decreasing when the point sequence is compressed.

Further, according to the numerical control system 1 of the embodiment, the numerical control device 100 defines the position V at which the operation is executed by using a length. In this manner, the numerical control device 100 of the embodiment can set the position V not only to an end point but also to a position between an end point and an end point.

Further, according to the numerical control system 1 of the embodiment, examples of the operation instructed by the output command include laser machining, gas cutting, and electrical discharge machining. Thus, the numerical control device 100 of the embodiment can cause the industrial machine 200 to execute laser machining, gas cutting, electrical discharge machining, or the like.

The above-mentioned embodiment can be modified as follows. In the above-mentioned embodiment, the indicator Ii is a distance of movement from the position V(i−1) to the position Vi along the interpolation curve M. However, the numerical control device 100 may use, in place thereof, an indicator Ii indicating a distance of movement from a different position to the position Vi. The different position is, for example, the point Q(j−1), the point Q0, or the like.

In the above-mentioned embodiment, the position V is defined by using the length. Further, in the above-mentioned embodiment, the indicator I indicates a length. However, the position V may be defined by using something other than the length, such as time, coordinates, a ratio, or the like. Further, the indicator I may indicate something other than the length, such as time, coordinates, a ratio, or the like. The following cases (α1) to (α4) represent examples of cases in which the position V is defined by using something other than the length. However, description of parts similar to the above-mentioned embodiment is basically omitted.

### (α1) Case 1 of Defining the Position V by Using Time

A time required for movement from the point P(i−1) to the point Pi is represented by Ti. A time required for movement from the point Q(j−1) to the point Qj is represented by Uj. The processor 110 uses the time Ti in place of the length of the curve Li between the end points in the expression (3) and the expression (4). Further, the processor 110 uses the time Uj in place of the length of the interpolation curve Mj in the expression (3).

In (α1), the indicator I indicates a length of the time required for advancing the section in which the operation instructed by the output command is executed. The processor 110 uses, in (α1), a time E(a−1) and a time Ea in place of the distance D(a−1) and the distance Da. Thus, in the case of i>k1+1, the position V(i−1) is a position advanced from the position of the point Q(j−1) along the interpolation curve Mj until the time E(a−1) elapses. In the case of i≠k2, the position Vi is a position advanced from the position of the point Q(j−1) along the interpolation curve Mj until the time Ea elapses.

(α2) Case 2 in which the Position V is Defined by Using Time

Unlike (α1), the processor 110 obtains the compression ratio R similarly to the above-mentioned embodiment. Other points are similar to (α1).

(α3) Case in which the Position V is Defined by Using a Ratio

In the case of i>k1+1, the position V(i−1) is a position advanced by (a ratio F(a−1) of the length of the interpolation curve Mj) (=Mj×F(a−1)) from the position of the point Q(j−1) along the interpolation curve Mj. The ratio F(a−1) is (a sum of the lengths from a curve L(k1+1) between the end points to a curve L(i−1) between the end points) corresponding to (a sum of the lengths of the curves L between the end points before compression of the interpolation curve Mj). That is, the following is satisfied.

$$\begin{matrix}[ Math . 9 ] & \\ {F}_{a - 1} = \frac{{\sum }_{s = k 1 + 1}^{i - 1} ‖ {L}_{s} ‖}{{\sum }_{s = k 1 + 1}^{k 2} ‖ {L}_{s} ‖} & ( 9 )\end{matrix}$$

In the case of i≠k2, the position Vi is a position advanced by (a ratio Fa of the length of the interpolation curve Mj) (=Mj×Fa) from the position of the point Q(j−1) along the interpolation curve Mj. The ratio Fa is (a sum of the lengths from the curve L(k1+1) between the end points to the curve Li between the end points) corresponding to (a sum of the lengths of the curves L between the end points before compression of the interpolation curve Mj). That is, the following is satisfied.

$$\begin{matrix}[ Math . 10 ] & \\ {F}_{a} = \frac{{\sum }_{s = k 1 + 1}^{i} ‖ {L}_{s} ‖}{{\sum }_{s = k 1 + 1}^{k 2} ‖ {L}_{s} ‖} & ( 10 )\end{matrix}$$

Note that the ratio F is a type of the indicator I, and is an indicator I indicating the ratio.
(α4) Case in which the Position V is Defined by Using Coordinates

A position closest to the point P(i−1) on the interpolation curve Mj is represented by a position V(i−1). A position closest to the point Pi on the interpolation curve Mj is represented by a position Vi. The coordinates of the position V(i−1) are represented by (XV(i−1), YV(i−1)), and the coordinates of the position Vi are represented by (XVi, YVi). The coordinates (XV(i−1), YV(i−1)) and the coordinates (XVi, YVi) are types of the indicator I, and are indicators I indicating the coordinates.

As described above, according to the numerical control system 1 of the embodiment, the numerical control device 100 defines the position V at which the operation is executed by using the time, the coordinates, the ratio, or the like, other than the length. In this manner, the numerical control device 100 of the embodiment can set the position V not only to an end point but also to a position between an end point and an end point.

The processor 110 may implement a part or the whole of the processing executed by the program in the above-mentioned embodiment by a hardware configuration of a circuit.

The program for implementing the processing of the embodiment is, for example, transferred in a state of being stored in a device. However, this device may be transferred in a state of not storing the program. In addition, the program may be separately transferred and may be written into the device. The transfer of the program at this time can be achieved by, for example, storing the program into a removable storage medium or downloading the program via a network such as the Internet or a LAN (local area network).

An embodiment of the present invention has been described above, but the embodiment is described as an example and does not limit the scope of the present invention. The embodiment of the present invention can be embodied in various modes without departing from the gist of the present invention.

### EXPLANATION OF REFERENCE NUMERALS

1 numerical control system
100 numerical control device
110 processor
111 program analyzing unit
112 point sequence compressing unit
113 interpolation processing unit
114 drive axis control unit
115 output control unit
116 command holding unit
117 indicator calculating unit
120 ROM
130 RAM
140 auxiliary storage device
150 control interface
160 bus
200 industrial machine

1. A numerical control device comprising:
a compressing unit that compresses a first command point sequence to create a second command point sequence;
a calculating unit that calculates an execution position of the operation in the second command point sequence, for a first output command that is held by the first command point sequence and instructs an industrial machine to execute the operation; and
a holding unit that causes the second command point sequence to hold a second output command for instructing the industrial machine to execute the operation at the execution position.

2. The numerical control device according to claim 1, wherein the calculating unit defines the execution position by using a length, coordinates, a ratio, or time.

3. The numerical control device according to claim 2, wherein the calculating unit defines the execution position by using a length of a section in which the operation is executed.

4. The numerical control device according to claim 1, wherein the operation includes at least one selected from laser machining, gas cutting, and electrical discharge machining.

5. A non-transitory computer readable medium storing a program for causing a processor included in a numerical control device to function as:
a compressing unit that compresses a first command point sequence to create a second command point sequence;
a calculating unit that calculates an execution position of the operation in the second command point sequence, for a first output command that is held by the first command point sequence and instructs an industrial machine to execute the operation; and
a holding unit that causes the second command point sequence to hold a second output command for instructing the industrial machine to execute the operation at the execution position.
